(19) United States
(12) Patent Application Publication
(10) Pub. No.: US 2022/0178197 A1
(43) Pub. Date: Jun. 9, 2022

(54) Protective Window Barrier

(71) Applicant: Timothy Oswald, Waterman, IL (US)

(72) Inventor: Timothy Oswald, Waterman, IL (US)

(21) Appl. No.: 17/478,101

(22) Filed: Sep. 17, 2021

Related U.S. Application Data
(60) Provisional application No. 63/122,625, filed on Dec. 8, 2020.

(51) Int. Cl. E06B 9/01

(52) U.S. Cl. CPC E06B 9/01; E06B 2009/002

(57) ABSTRACT

The present invention relates to a protective window barrier or cover that ensures the privacy of individuals inside a housing dwelling, while allowing natural light and fresh air to penetrate through the windows. The protective window cover comprises a pair of lateral frames for fastening to wall structures of a window frame, on which a plurality of translucent and mottled panels are fastened in an overlapping and staggered manner such that each pair of adjacent panels creates a gap. The gap between each pair of adjacent panels provides a passage for fresh air and light transmission across the panels while providing privacy due to an obstructed view from an outside viewer.

### CROSS-REFERENCE TO RELATED APPLICATION

The present application claims priority to, and the benefit of, U.S. Provisional Application No. 63/122,625, which was filed on Dec. 8, 2020 and is incorporated herein by reference in its entirety.

### FIELD OF THE INVENTION

The present invention relates generally to the field of windows. More specifically, the present invention relates to a protective window barrier featuring a plurality of staggered panels that overlap each other to ensure light and air can travel through the window to a home interior, while maintaining the privacy of the people inside the home. The staggered panels are made up of translucent, mottled, and/or frosted composition that ensures outside eyes cannot see through the panels and into the window. The panels of the secure window barrier can be made from a material comprising of a plastic, a Plexiglas, a glass and other suitable materials. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, in every conventional housing or dwelling construction (e.g., single and multifamily homes, apartments, townhouses, et. al.), windows are installed during construction to provide ventilation and outside views for the individuals living in the dwelling property or dwelling. A window is a vented barrier provided in a wall opening to admit light and air into the structure. Typically, the windows in any housing construction, especially in homes, are equipped with a mesh screen to keep insects out and small debris from entering inside the home, while functioning as a protective barrier. However, with the standard mesh screens attached to the windows, people from outside can easily see through the window and obtain views inside the dwelling. The conventional screened barriers do not offer privacy when the window is opened and cause an invasion of privacy to the individuals inside the dwelling.

To prevent people outside a dwelling from interfering with the privacy of individuals inside a standard window, people can use a variety of window coverings available in the state of the art. The window coverings for protecting privacy of the individuals may be opaque to completely block the view of the people from inside, and that does not allow others to view inside housing through the windows. Although the aforementioned window coverings ensure privacy to the individuals inside the dwelling, these window coverings are required to be removed in order to allow light and air to pass through the window. In situations where the window coverings are removed for light transmission and air ventilation, people outside the dwelling can easily see through the windows, which interferes with the individual's privacy inside the dwelling. Heretofore known devices do not provide a window barrier that ensures the privacy of the individuals within a dwelling while the windows are open.

Therefore, there exists a long-felt need in the art for a window barrier that can be attached to standard window panes to ensure privacy of the individuals inside the dwelling. There is also a long-felt need in the art for a window barrier that allows the light and air to pass through the window opening, while maintaining the privacy of the users. Additionally, there is a long-felt need in the art for a window barrier that does not require the barrier to be completely removed to allow the light and wind to pass through the window openings. Moreover, there is a long-felt need in the art for a window barrier that ensures individuals outside a dwelling cannot view through the windows, and cannot invade the privacy of individuals inside the dwelling. Further, there is a long-felt need in the art for a window barrier that is neither opaque nor transparent. Furthermore, there is a long-felt need in the art for a window barrier that can be easily attached to the windows of any housing construction. Finally, there is a long-felt need in the art for a window barrier that ensures light and air can travel through window openings to a home interior, while providing privacy to the occupants.

The subject matter disclosed and claimed herein, in one potential embodiment thereof, comprises a protective window barrier privacy device that is configured and designed to fit in a window frame for providing privacy, fresh air, and natural light. The protective window barrier privacy device further comprises: an upper lateral frame having a first side and a second side, and having clamps, clips, brackets or similar hardware at opposing ends for fastening the upper lateral frame to the wall structures of the window frame; a lower lateral frame having a first side and a second side and having clamps at opposing ends for fastening the lower lateral frame to wall structures of the window frame; a plurality of frosted and translucent panels fastened to the upper lateral frame and the lower lateral frame; wherein, adjacent panels are fastened to opposite sides of the upper lateral frame and the lower lateral frame in an overlapping manner, such that a gap is created between adjacent panels for fresh air to pass through. The frosted and translucent panels allow light to pass through and prevent onlookers from seeing through the panels.

In this manner, the novel protective window barrier of the present invention accomplishes all of the forgoing objectives, and provides a relatively safe, easy and convenient solution that functions as a protective barrier to ensure privacy of individuals inside housing construction, while allowing the light and wind to pass through the windows. The protective window barrier of the present invention includes a translucent surface that ensures outside viewers cannot see through the windows. The protective window barrier can be used with any conventional window panes of any housing construction, as per the desires of the users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment thereof, comprises a protective window barrier privacy device that is configured and designed to fit in a window frame for providing privacy, fresh air and natural light. The protective window barrier privacy device further comprises: an upper lateral frame having a first side and a second side, and having clamps at opposing ends for fastening the upper lateral frame to wall structures of the window frame; a lower lateral frame having a first side and a second side, and having clamps at opposing ends for fastening the lower lateral frame to wall structures of the window frame; a plurality of frosted and translucent panels fastened to the upper lateral frame and the lower lateral frame; wherein, adjacent panels are fastened to opposite sides of the upper lateral frame and the lower lateral frame in an overlapping manner, such that a gap is created between adjacent panels for fresh air to pass through. The frosted and translucent panels allow light to pass through and prevent onlookers from seeing through the panels.

In a further embodiment of the present invention, a window protective cover is disclosed. The window protective cover includes: a pair of lateral frames for fastening to the wall structures of a window; a plurality of translucent and mottled panels fastened in an overlapping manner to the pair of lateral frames wherein the adjacent panels are fastened on opposite sides of the pair of lateral frames to create a gap for providing a passage for fresh air; and the panels provide light transmission across the panels and provide privacy due to an obstructed view.

In a further embodiment of the present invention, a method for illuminating and receiving fresh air in an area through a window while maintaining privacy is disclosed. The method includes: providing a protective window barrier attachable to a window frame; the protective window barrier including an upper lateral arm and a lower lateral arm; a plurality of frosted and mottled panels; each panel is configured to allow light to pass through but prevent viewing across or through the panel; each panel is fastened to both the upper lateral arm and the lower lateral arm; and, each pair of adjacent panels are fastened to opposite sides of the upper lateral arm and the lower lateral arm for creating a gap to allow fresh air to pass there through.

In yet another embodiment of the present invention, the panels are staggered and overlapped to ensure light and air can travel through gaps in the window barrier. The mottled or frosted composition of the panels maintain privacy despite the window being opened. The lateral arms are clamped onto an open window frame via a screw mechanism, thereby firmly securing the barrier inside the window frame.

In yet a further embodiment of the present invention, the thickness of each panel can generally be from about 2 millimeters to about 5 millimeters, and can be configured to protect from ultra-violet rays. The panels can be slightly flexible. The fastening mechanism for fastening the lateral frames includes clamps and screws used for screwing the frames to grooves in the wall structures of the windows, and/or expanding the length of the screws for retention within the window openings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a protective window barrier of the present invention in accordance with the disclosed architecture;

FIG. 2 illustrates a front plan partially cross-sectional view of one potential embodiment showing securement mechanism of the lateral frames of the window cover to a window frame in accordance with the disclosed architecture;

FIG. 3 illustrates a perspective view of one potential embodiment showing how the window barrier of the present invention fits within the walls of a window in accordance with the disclosed architecture; and

FIG. 4 illustrates a perspective view of one potential embodiment showing how the window barrier of the present invention improves security and could help in preventing a child from falling out of a window while also providing privacy in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a window barrier that can be attached to standard window panes to ensure privacy of the individuals inside the dwelling. There is also a long-felt need in the art for a window barrier that allows the light and air to pass through the window opening while maintaining the privacy of the users. Additionally, there is a long-felt need in the art for a window barrier that does not require the barrier to be completely removed to allow the light and wind to pass through the window openings. Moreover, there is a long-felt need in the art for a window barrier that ensures individuals outside a dwelling cannot view through the windows, and cannot invade the privacy of individuals inside the dwelling. Further, there is a long-felt need in the art for a window barrier that is neither opaque nor transparent. Furthermore, there is a long-felt need in the art for a window barrier that can be easily attached to the windows of any housing construction. Finally, there is a long-felt need in the art for a window barrier that ensures light and air can travel through the window openings to a home interior, while providing privacy to the occupants.

The present invention, in one potential embodiment, includes a novel window protective cover. The window protective cover includes: a pair of lateral frames for fastening to or securing there between wall structures of a window; a plurality of translucent and mottled panels fastened in an overlapping manner to the pair of lateral frames, wherein the adjacent panels are fastened on opposite sides of the pair of lateral frames to create a gap for providing a passage for fresh air; and the panels provide light transmission across the panels and provide privacy due to an obstructed view.

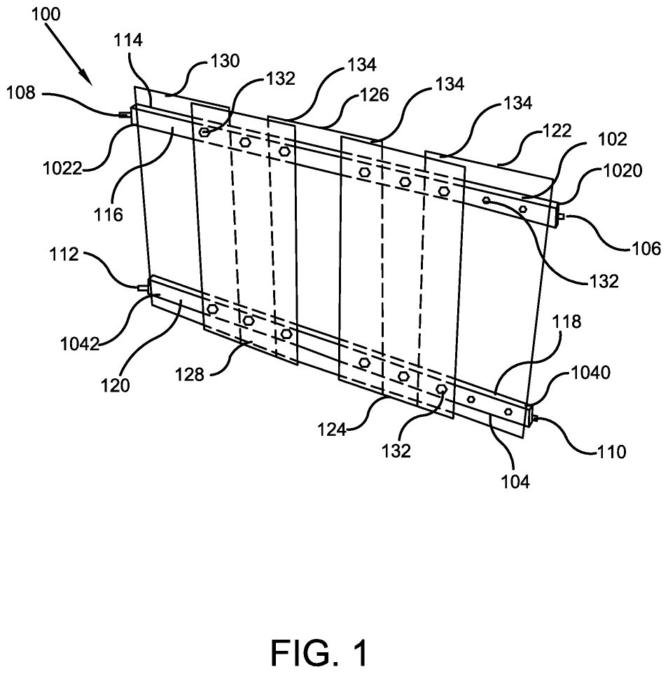

Referring initially to the drawings, FIG. 1 illustrates a perspective view of one potential embodiment of a protective window barrier of the present invention in accordance with the disclosed architecture. The protective window barrier or window cover 100 of the present invention includes a frosted plastic or glass panel for attaching to a window frame and that functions as an obstruction to a clear interior view for individuals located outside of a dwelling. The window cover 100 clamps onto an open window frame via a screw mechanism, or expansion clamp, for maintaining privacy.

The window cover 100 includes an upper lateral frame 102 and a lower lateral frame 104. Both the upper lateral frame 102 and the lower lateral frame 104 are constructed of a sturdy material such as a wood, metal or heavy-duty plastic. The upper lateral frame 102 includes a first fastening clamp 106 and expansion screw 206 at a first end 1020, and a second fastening clamp 108 and expansion screw 208 at a second end 1022. The opposing fastening clamps 106, 108 enable the upper lateral frame 102 to be secured to a window frame by screwing expansion screws 206, 208 into respective fastening grooves 2020, 2040 at opposing side walls of a window frame. The lower lateral frame 104 includes a first fastening clamp 110 and expansion screw 210 at a first end 1040, and a second fastening clamp 112 and expansion screw 212 at a second end 1042. The opposing fastening clamps 110, 112 enable the lower lateral frame 104 to be secured to the window frame by screwing expansion screws 210, 212 into respective fastening grooves 2022, 2042 at opposing side walls of the window frame.

The window cover 100 includes a plurality of translucent, mottled material panels positioned in a staggered orientation that are fastened to the upper lateral frame 102 and the lower lateral frame 104. Each panel is positioned in a coronal plane, thereby ensuring light travels through the panels, while maintaining privacy due to the translucent mottled material of the panels. A first group of panels 122, 126, 130 can be fastened on a first side 114 of the upper lateral frame 102 and on a first side 118 of the lower lateral frame 104. A second group of panels 124, 128 are fastened on a second side 116 of the upper lateral frame 102 and on a second side 120 of the lower lateral frame 104, such that adjacent panels slightly overlap one another. Gaps 134 are created between the adjacent panels, thereby allowing fresh air to pass through the panels while maintaining privacy.

As shown, a first panel 122 is fastened to the first side 114 of the upper frame 102 and the first side 118 of the lower frame 104, using a plurality of mechanical fasteners 132. A second panel 124 is positioned adjacent to the first panel 122, and is fastened to the second side 116 of the upper frame 102 and the second side 120 of the lower frame 104, using a plurality of mechanical fasteners 132. The first panel 122 and the second panel 124 are positioned such that they slightly overlap with each other. The mounting of panels 122, 124 to opposite sides of the frames 102, 104 creates a gap 134 with a width generally equivalent to the width of the upper lateral frame 102 and the lower lateral frame 104.

Similarly, a third panel 126 positioned adjacent to the second panel 124 can be fastened to the first side 114 of the upper frame 102 and the first side 118 of the lower frame 104 using a plurality of mechanical fasteners 132. The third panel 126 and the second panel 124 are positioned such that they slightly overlap with each other, and create a slight gap 134 with a width generally equivalent to the width of the upper lateral frame 102 and the lower lateral frame 104. The fourth panel 128 and the fifth panel 130 can be positioned in a similar staggered manner enabling them to function as a visual barrier without preventing natural light or fresh air penetration.

Using the fastening clamps 106, 108, 110, 112, and expansion screws 206, 208, 210, 212, the window cover 100 clamps onto, or into, an open window frame via a rotation of the expansion screws to firmly secure the cover 100 inside the window frame. The mottled or frosted composition of the panels 122, 124, 126, 128, 130 maintains privacy and security, despite the window being opened. It is to be appreciated that the size and number of panels used in the window cover 100 are not limited and can vary, depending on the window size and the length of upper/lower lateral frames.

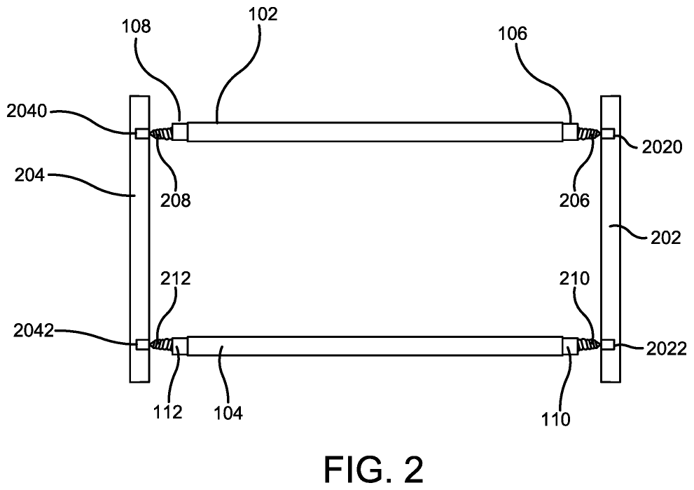

FIG. 2 illustrates a front perspective view showing a securement mechanism of the lateral frames of the window cover to a window frame in accordance with the disclosed architecture. The fastening clamp 106 of the upper lateral frame 102 can be screwed to a groove 2020 of a first vertical wall 202 of a window frame using a mechanical screw 206. Similarly, the fastening clamp 108 of the upper lateral frame 102 can be screwed to a groove 2040 of a second vertical wall 202 of a window frame using a mechanical screw 208. The mechanical screws 206, 208 are easily screwed within the grooves 2020, 2040 and the fastening clamps 106, 108.

For securing the lower lateral frame 104, a fastening clamp 110 of the lower lateral frame 104 can be screwed to a groove 2022 of the first vertical wall 202 using a mechanical screw 210. Similarly, the fastening clamp 112 of the lower lateral frame 104 can be screwed to a groove 2042 of the second vertical wall 204 using a mechanical screw 212.

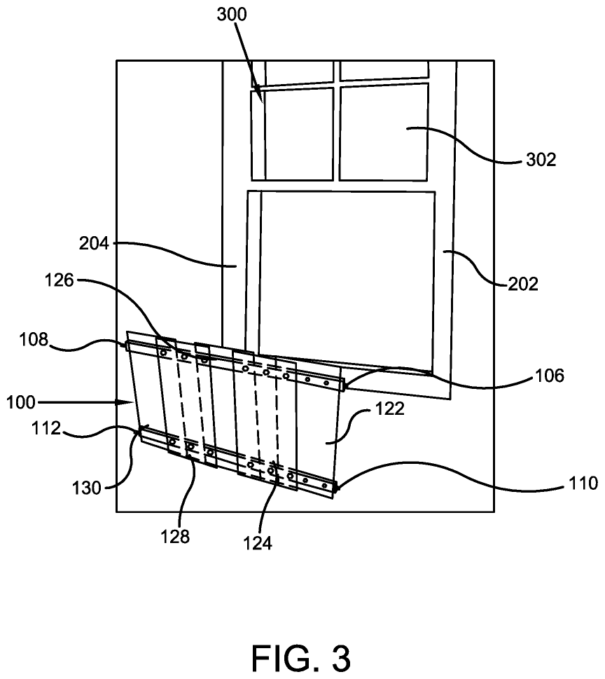

FIG. 3 illustrates a perspective view showing how the window barrier of the present invention fits within walls of a window frame in accordance with the disclosed architecture. Privacy through a window 300 is lost when a window door 302 is opened. The window barrier 100 fits within the vertical walls 202, 204 of the window frame 300 using the clamps 106, 108, 110, 112 and expansion screws 206, 208, 210, 212, as described in FIG. 2. Once the window barrier 100 is fit within the window frame 300, the frosted plastic or glass panels 122, 124, 126, 128, 130 function as a visual barrier, while allowing natural light and fresh air penetration. The mottled or frosted composition of the panels 122, 124, 126, 128, 130 maintain privacy, despite the window 302 being open.

In practice, a single user can install the window barrier 100 without any professional help, by fitting each clamp in its corresponding groove on a window wall structure. As such, a single user can install and finish installation of the window barrier 100 quickly and easily and with little need for extensive training and experience. Additionally, the panels 122, 124, 126, 128, 130 can be prefabricated and fastened in window frames, such that the panels closely match window sizes and are dimensionally to scale.

The window barrier 100 is for shading and covering a window opening in a building, such as a residence, office or other inhabited space. It should be noted that the window barrier 100 is installable in a window opening in place of an existing window section, on the inside of an existing window frame unit or on the outside of an existing window frame unit.

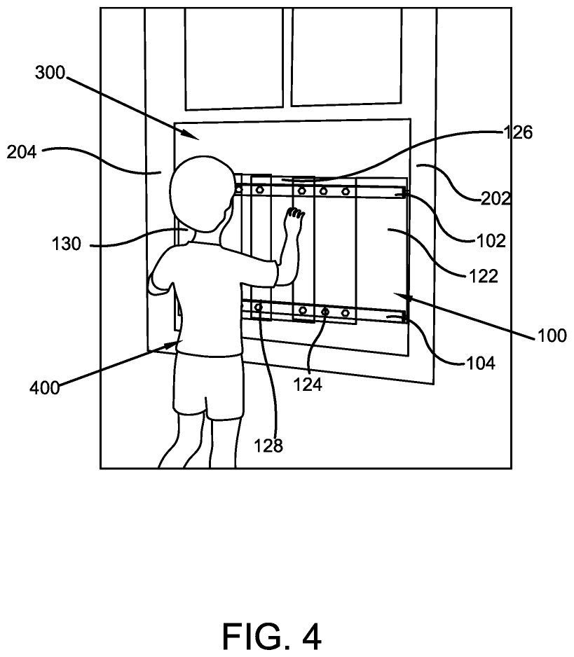

FIG. 4 illustrates a perspective view showing how the window barrier of the present invention improves security and could prevent a child from falling while providing privacy in accordance with the disclosed architecture. Once the window barrier 100 is fitted within the window frame structure 202, 204 of the window 300, the window barrier 100 provides privacy through the mottled and frosted panels 122, 124, 126, 128, 130. A person positioned outside is prohibited from seeing through the window barrier 100 due to the frosted and mottled nature of the panels 122, 124, 126, 128, 130. Fresh air is maintained through the staggered positioning and the gaps 134 between the adjacent panels, and natural light can easily pass through the translucent panels 122, 124, 126, 128, 130. Thus, even when the window door is open, the window barrier 100 provides protection to small children 400 and prevents them from falling through the window 300. The frames 102, 104 are used for fastening the window barrier 100 to the wall structures 202, 204. It should be appreciated that the window barrier 100 can come in various sizes to adjustably fit to the different window frame sizes. Additional or selective placement of the grooves in the window walls 202, 204 for fitting the frames 102, 104, can be drilled easily using a power drill tool.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “protective window barrier”, “protective window barrier privacy device”, “window protective cover”, “window cover”, “window barrier”, “secure window barrier”, and “barrier”, are interchangeable and refer to the protective window barrier 100 of the present invention.

Notwithstanding the forgoing, the protective window barrier 100 of the present invention can be of any suitable size and configuration as is known in the art without affecting the overall concept of the invention, provided that it accomplishes the above-stated objectives. One of ordinary skill in the art will appreciate that the size, configuration, and material of the protective window barrier 100 as shown in the FIGS. are for illustrative purposes only, and that many other sizes and shapes of the protective window barrier 100 are well within the scope of the present disclosure. Although the dimensions of the protective window barrier 100 are important design parameters for user convenience, the protective window barrier 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A window barrier privacy device comprising:
a plurality of panels, wherein each of said plurality of panels is translucent for light transmission therethrough;
an upper lateral frame;
a lower lateral frame;
at least a first panel mounted to a first side of said upper and said lower frames, wherein said first panel is proximal to and staggered with a second panel;
said second panel mounted to a second side of said upper and said lower frames, wherein said second panel is proximal to and staggered with said first panel and a third panel; and
said third panel mounted to said first side of said upper and said lower frames, wherein said third panel is proximal to and staggered with said second panel and a fourth panel.

2. The window barrier privacy device of claim 1, wherein said fourth panel mounted to said second side of said upper and said lower frames, and further wherein said fourth panel is proximal to and staggered with said third panel and a fifth panel.

3. The window barrier privacy device of claim 2, wherein said fifth panel mounted to said first side of said upper and said lower frames, wherein said fifth panel is proximal to and staggered with said fourth panel.

4. The window barrier privacy device of claim 3, wherein said plurality of panels are mottled.

5. The window barrier privacy device of claim 3, wherein each of said plurality of panels is frosted.

6. The window barrier privacy device of claim 5, wherein said plurality of panels comprise a material selected from a group consisting of a plastic, a Plexiglas and a glass.

7. The window barrier privacy device of claim 6, wherein each of said plurality of panels are comprised of a thickness generally from about 2 mm to about 5 mm.

8. A window barrier privacy device comprising:
a plurality of panels, wherein each of said plurality of panels is translucent for light transmission therethrough;
an upper lateral frame;
a lower lateral frame;
at least a first panel mounted to a first side of said upper and said lower frames, wherein said first panel is proximal to and staggered with a second panel;
said second panel mounted to a second side of said upper and said lower frames, wherein said second panel is proximal to and staggered with said first panel and a third panel;
said third panel mounted to said first side of said upper and said lower frames, wherein said third panel is proximal to and staggered with said second panel and a fourth panel;
said fourth panel mounted to said second side of said upper and said lower frames, wherein said fourth panel is proximal to and staggered with said third panel and a fifth panel;
said fifth panel mounted to said first side of said upper and said lower frames, wherein said fifth panel is proximal to and staggered with said fourth panel;
said first panel, said third panel, and said fifth panel are positioned in a first plane; and
said second panel and said fourth panel are positioned in a second plane, wherein said first plane is spaced from said second plane.

9. The window barrier privacy device of claim 8, wherein said plurality of panels are mottled.

10. The window barrier privacy device of claim 8, wherein said plurality of panels are frosted.

11. The window barrier privacy device of claim 8, wherein said plurality of panels comprise a material selected from a group consisting of a plastic, a Plexiglas, and a glass.

12. The window barrier privacy device of claim 8, wherein each of said plurality of panels comprise a thickness generally from about 2 mm to about 5 mm.

13. A window barrier privacy device comprising:
a plurality of panels;
an upper lateral frame, wherein said upper lateral frame includes expansion screws mounted to opposing ends of said upper lateral frame;
a lower lateral frame, wherein said lower lateral frame includes expansion screws mounted to opposing ends of said lower lateral frame;
said upper lateral frame and said lower lateral frame mounted between opposing vertical walls of a window frame;
at least a first panel mounted to a first side of said upper and said lower frames, wherein said first panel is proximal to and staggered with a second panel;
said second panel mounted to a second side of said upper and said lower frames, wherein said second panel is proximal to and staggered with said first panel and a third panel;
said third panel mounted to said first side of said upper and said lower frames, wherein said third panel is proximal to and staggered with said second panel and a fourth panel; and
said fourth panel mounted to said second side of said upper and said lower frames, wherein said fourth panel is proximal to and staggered with said third panel.

14. The window barrier privacy device of claim 13, wherein said first panel and said third panel are positioned in a first plane, said second panel and said fourth panel are positioned in a second plane, and further wherein said first plane is spaced apart from said second plane.

15. The window barrier privacy device of claim 14, wherein each of said plurality of panels is translucent for light transmission therethrough.

16. The window barrier privacy device of claim 14, wherein each of said plurality of panels is mottled for light transmission therethrough.

17. The window barrier privacy device of claim 14, wherein said plurality of panels are frosted for light transmission therethrough.

18. The window barrier privacy device of claim 14, wherein said plurality of panels comprise a material selected from a group consisting of a plastic, a Plexiglas and a glass.

19. The window barrier privacy device of claim 14, wherein each of said plurality of panels comprises a thickness generally from about 2 mm to about 5 mm.

20. The window barrier privacy device of claim 14 further comprising a fifth panel mounted to said first side of said upper and said lower frames, wherein said fifth panel is proximal to and staggered with said fourth panel.
